(19) United States
(12) Patent Application Publication
(10) Pub. No.: US 2005/0032021 A1
(43) Pub. Date: Feb. 10, 2005

(54) Dental hand instrument

(75) Inventors: Johann Hain, Heppenheim (DE); Ulf Stein, Rimbach (DE)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Sirona Dental Systems GmbH

(21) Appl. No.: 10/933,302

(22) Filed: Sep. 3, 2004

Related U.S. Application Data
(63) Continuation of application No. PCT/DE03/00678, filed on Mar. 4, 2003.

(30) Foreign Application Priority Data
Mar. 4, 2002 (DE) 102 09 194.3
Mar. 12, 2002 (DE) 102 10 777.7

(51) Int. Cl. A61C 1/12

(52) U.S. Cl. 433/84; 433/126

(57) ABSTRACT

A dental hand instrument has two structurally distinct functional units capable of interconnection. One functional unit comprises a head piece equipped with a tool a portion of grip element which at least has the function of making it possible to hold the hand instrument in the hand, connecting element, and a driving mechanism or means for transmitting the energy therefor. A second functional unit comprises at least one carrier for conduits and/or conductors for media and signals respectively. The first functional unit forms a drive-independent, hand-held unit, having an external housing that is closed all round, and contains means for the attach-ment of the second functional unit (F1/2).

### BACKGROUND OF THE INVENTION

The invention relates to a dental hand instrument having a first functional unit containing a functional part, a grip element, a connecting element for the attachment of a supply element for media such as water, air, electric current, light and/or signals, and a second functional unit mounted on the first functional unit.

U.S. Pat. No. 5,674,068 discloses a dental handpiece that has a coupling device for a driving motor, in which a connecting channel leads to an external angular rear joining conduit. An external flexible conduit is fixed thereto, the other end of which is attached to a front joining conduit on the head of the handpiece.

U.S. Pat. No. 6,102,695 discloses a dental hand instrument in which a lighting unit for illuminating the preparation site and also an image-transmitting device is provided with an image conductor. The lighting unit comprises an optical fiber installed in the hand instrument and extending up to the head piece, and the image-transmitting device comprises a bundle of optical fibers and an image converter in the form of a CCD camera. The optical fiber of the lighting unit and also the conduits conveying the cooling media for cooling the preparation site are fixed in the interior of the grip element. The image conductor and CCD camera of the image-transmitting device are removably disposed on the underside of the grip element. The grip element is provided with a longitudinal groove on its underside for the accommodation of the image conductor. The longitudinal groove merges into a slot for the image conductor in its front region facing the head piece. The CCD camera is removably mounted on the outside of the connecting element. For use of the hand instrument without the image conductor, a blank is provided which can be attached to the grip element instead of the image conductor, which blank has substantially the same dimensions as the image conductor.

In the case of the known hand instrument it is possible, when auto-claving with superheated steam, to remove the image conductor and the CCD camera from the hand instrument's grip element to be auto-claved, but the optical fibers provided for illumination of the treatment site and also the media-conveying parts possibly still present remain fixed in said grip element of the hand instrument. Replacement of any of the media-conveying parts, for example, an optical fiber or an electric conductor, is not possible without dismantling the hand instrument. Another drawback may be seen to be the fact that any desirable variant of a particular type of handpiece, relating to the implementation of the media, must be separately designed with respect to its structure and the manufacturing technology required therefor.

### SUMMARY OF THE INVENTION

It is an object of the invention to effect improvement on the prior art and to provide a dental hand instrument of the kind mentioned above which does not suffer from the aforementioned drawbacks and with which, in particular, various hand instruments of manifold design can be produced for different application-specific types of media using comparatively simple measures.

The invention is based on the idea of dividing the hand instrument into two components with respect to functionality and hygienic considerations. The dental hand instrument has a first functional unit comprising a functional part, a grip element, a connecting element for the attachment of a supply element for media such as air, water, electric current, light and/or signals, and also a second functional unit mounted on the first functional unit and comprising at least one media carrier for the transfer of media and/or signals. The second functional unit contains at least one media carrier for conduits and/or conductors for transferring media and signals respectively.

By dividing the hand instrument into a fully functional basic module on the one hand and one or more media carriers on the other hand, it is possible to produce different versions for each type of handpiece as regards the implementation of the media and/or signals without having to modify the basic module. Another advantage resides in the fact that the elements which hold the conduits and/or conductors for media and signals respectively can be easily removed from the basic module for cleaning, sterilization or replacement purposes.

According to a development of the invention, the first functional unit can comprise a driving mechanism or means for transmitting driving energy.

Other embodiments of the invention are defined in the sub-claims.

### BRIEF DESCRIPTION OF THE DRAWINGS

A number of embodiments of the invention are explained in greater detail with reference to the drawings, in which:

FIGS. 1 to 4 are greatly simplified illustrations of four different hand instruments of the invention with the supply elements assigned thereto,

FIG. 5 is a perspective view of the hand instrument shown in FIG. 1,

FIG. 6 is a perspective view of the hand instrument shown in FIG. 1 with detached media carrier,

FIG. 7 is a perspective view of the media carrier shown in FIG. 1,

FIG. 8 shows the media carrier shown in FIG. 7 from a different viewpoint,

FIG. 9 is a perspective view of another variant of a media carrier,

FIG. 10 shows the head piece of a hand instrument comprising another variant of a media carrier,

FIG. 11 shows another variant of a media carrier,

FIG. 12 shows yet another variant of a media carrier.

FIG. 13 shows a hand instrument having a different form of media carrier,

FIG. 14 shows a hand instrument having another variant of a media carrier,

FIG. 15 is a cross-section of a hand instrument comprising a plurality of media carriers,

FIG. 16 is a perspective view of a hand instrument equipped with two media carriers,

FIG. 17 shows a hand instrument having a flushed gap between the media carrier and the housing.

### DETAILED DESCRIPTION OF THE INVENTION

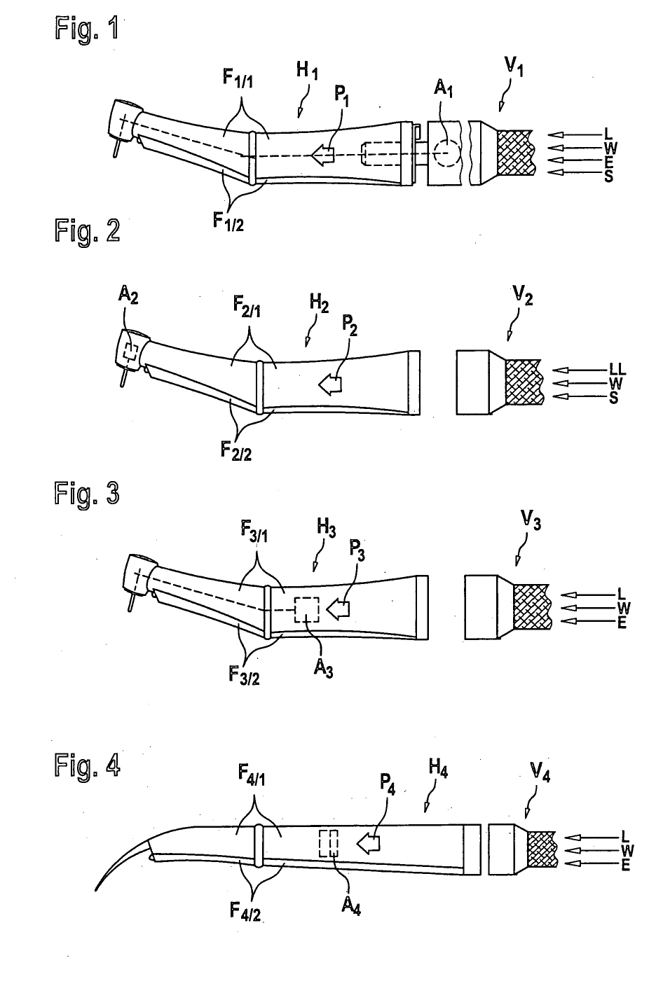

FIGS. 1 to 4 show, in a greatly simplified, diagrammatic form, four different hand instruments H1 to H4, to which driving energy P1 to P4 for drives Al to A4 is fed through supply conduits V1 to V4. Each of the hand instruments exhibits a first functional unit having a functional part 1 and a grip element 3. The part designated as the functional part is the part where the required function is carried out, that is to say, drilling, irradiation, spraying, powder blowing, etc., whilst the grip element is the part at which the handpiece is held in the hand.

The hand instrument H1 is a so-called angular handpiece, which serves to drive a tool mounted in the head piece, together forming the functional part, and which contains, in known manner, driving shafts (indicated in the drawing by a dashed line) which will be driven by an electromotive drive A1 to be attached to the hand instrument. The driving energy P1 fed to the hand instrument is in this case mechanical energy.

The hand instrument H2 is a so-called turbine handpiece having a driving mechanism A2 (turbine) disposed in the head piece. The driving energy P2 is in this case the propellant air passed to the turbine.

The hand instrument H3 is a hand instrument having an air motor A3 disposed in the grip element. The driving energy P3 is in this case the propellant air passed to the air motor.

The hand instrument H4 is a hand instrument having an integrated oscillator A4 (usually a supersonic or pneumatic oscillator), which causes the bit to carry out oscillating or similar movements. The driving energy P4 is in this case electric current or air passed to the supersonic or pneumatic oscillator A4.

The dental tool can alternatively be a sprayer. This means that water and air are forced through the tool in the first functional unit. Likewise possible is the use of a tool in the form of a powder blower. In this case a mixture of compressed air and powder is ejected through an outlet nozzle in the functional part, optionally with admixture of a liquid.

The dental tool can be in the form of a source of light of arbitrary wavelength. This light can be produced in the handpiece itself, for example, by means of diodes or incandescent lamps or alternatively it can be transmitted via the connecting element. The light can serve, for example, to accelerate curing processes.

Furthermore, the dental hand instrument can have a tool in the form of laser light. In this case a working bit can be adapted for the emission of laser light.

Finally, the dental tool can be a probe with or without driving means, which may be used, for example, to measure the depth of a root canal.

Furthermore, the differently constructed hand instruments supplied with different driving energies are used to convey or emit different media or signals via the supply conduits or conductors V1 to V4. These media designated in the drawings by arrows can be, inter alia:
air for forming a spray (L),
water for forming a spray (W),
electrical energy for operating a lamp (E),
light of any wavelength in the form of an optical fiber (LL), a laser light or picture information.

Furthermore, signals can be passed into the hand instrument from a control unit, disposed outside the hand instrument, or returned from the hand instrument to the control unit. These signals are indicated by (S) in the drawings. In particular, when the hand instrument is connected to a standard interface, additional external supply lines are necessary for media not available, at the computer interface.

The four different hand instruments have a common basic set-up. According to this set-up, the head piece, that portion of the hand instrument's grip element which is at least adapted to be held in the hand, and the connecting element for the attachment of flexible supply tubing or a driving part coupled thereto (as shown, for example, in FIG. 1) are in the form of a self-sufficient functional unit (basic module), to which basic module at least one media carrier can be removably attached, which media carrier contains, in particular, the conduits and/or conductors for conveying media and signals respectively.

In FIGS. 1 to 4, the basic module, i.e., the first functional unit, is designated by F1/1 for hand instrument H1 and the second functional unit for this hand instrument by F1/2, the other hand instruments H2 to H4 being designated in analogous manner.

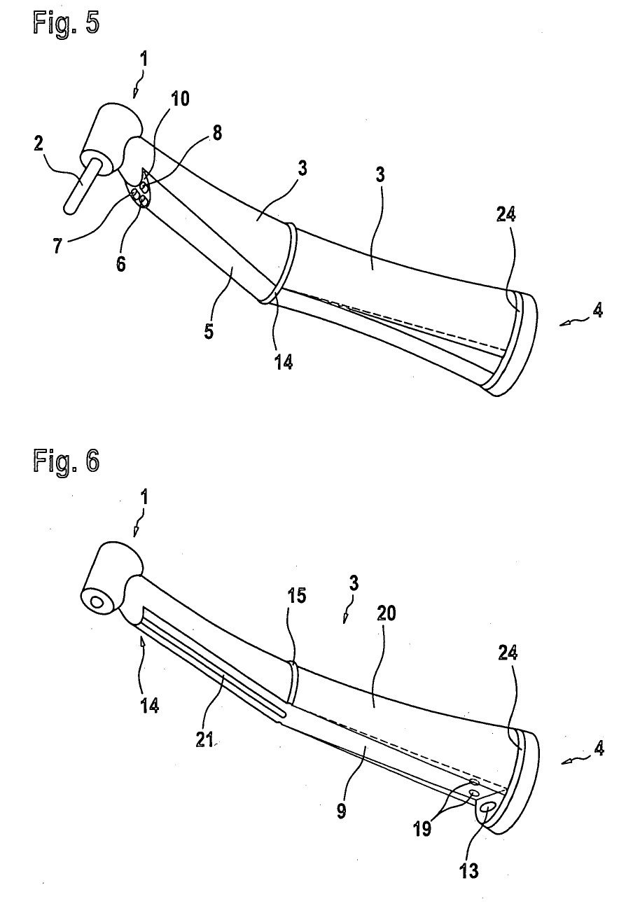

Details on the structure and design of the two functional units are explained below with reference to FIGS. 5 to 8 relating, by way of example, to hand instrument H1.

The basic module of the hand instrument is composed of a head piece 1, in which a tool 2, in this case a rotatable drilling tool, is mounted, a grip element 3, and a connecting element 4 for attaching a supply element (in this case flexible supply tubing V1 attached to a driving motor A1). Alternatively, an oscillating tool or a stationary bit having means for emission of laser light or some other form of energy may be provided as processing tool. Furthermore, any other dental tool can be used, such as a sprayer, laser light, light for effecting polymerization, a scaler, a video camera, and the like. The respective function is in all cases provided in the functional part of the first functional unit.

Connecting element 4 is drawn diagrammatically here but can be variously designed depending on the embodiment of the hand instrument and the appertaining supply element. In the case of a screw connection, the connecting element can have a thread, and in the case of a bayonet connection it can contain coupling elements extending into the grip element for the accommodation of, say, a coupling pin (FIG. 1).

The grip element 3 contains in its interior all parts necessary for driving the tool or for supplying it with energy, i.e., for example driving shafts and their bearings, etc.

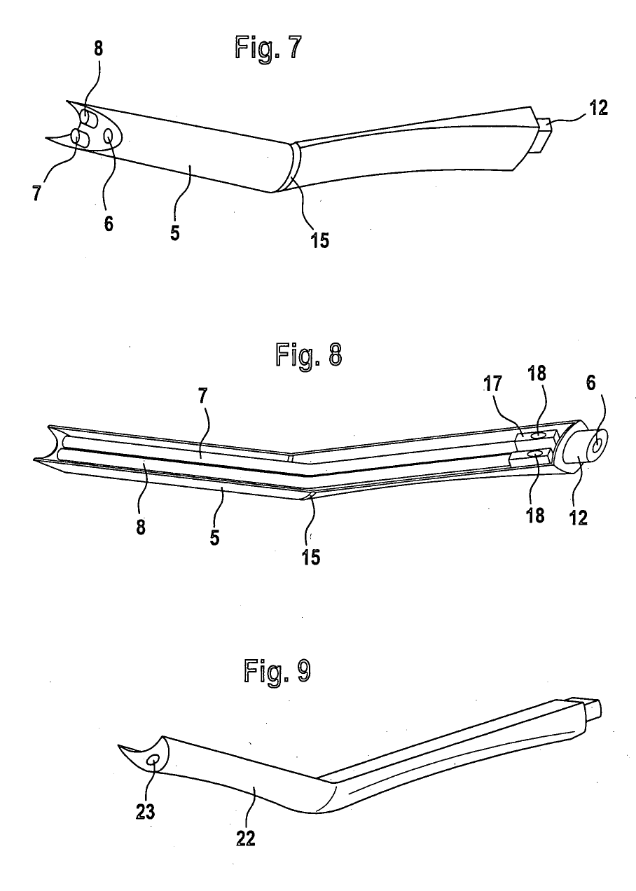

On the underside of grip element 3 there is situated a molded piece 5 serving as media carrier and containing an optical fiber 6 and also two fine tubes 7 and 8 for the supply of water to be sprayed and atomizing air. These parts together form the second functional unit. Molded piece 5 is designed such that it forms a continuation of the external contour of the hand instrument at least in the region where the hand instrument is to be held in the hand. For this purpose the housing 20 of grip element 3 has a recess 9 extending along the hand instrument, into which molded piece 5 can be inserted (FIG. 6). When inserted (FIG. 5), a part of the inclined end face 10 facing the head piece bears against a mating surface 11 of said head piece 1. The other end of molded piece 5 contains a pin 12 (FIGS. 7 and 8), which engages in a complementary recess 13 in connecting element 4.

The molded piece 5 is held in place on the hand instrument by means of a ring 14 which can be pushed onto grip element 3 and which snaps into a complementary notch 15 in molded piece 5 and in grip element 3. To lock the molded piece 5 axially, there may be provided, additionally or alternatively, a locking ring designated by reference numeral 24.

As an alternative to this locking and/or clamping ring, self-locking of the molded piece could be achieved, for example, by means of a snap-on lock fit. The molded piece and basic module may be interconnected, for example, by employing a type of dovetail joint. In this case there is achieved a positive fit at least at certain points. In the case of a resilient molded piece, snap-engagement in a groove would be conceivable.

As may be seen from FIG. 8, which is a top view of molded piece 5, molded piece 5 is boat-shaped. The two fine tubes 7 and 8 are held in the boat-shaped recess of molded piece 5 by clamping elements 16 such that they can be easily removed therefrom, if desired.

At their ends remote from the head piece the fine conduits 7, 8 are held in an insert 17, which has radial openings 18 that correspond to openings 19 disposed in handgrip element 3, by which means, when the units are interconnected, a transfer of media from the first functional unit, in this case the handgrip, to the second functional unit, in this case the molded piece, can take place.

Optical fiber 6 is also fixed in position in the molded piece by means of suitable retaining elements, particularly at its ends (see pin 12).

To facilitate fixing of fine conduits 7, 8 and/or the optical fiber (depending on the position of the parts in molded piece 5), the underside of housing 20 of grip element 3 is provided with a groove 21 extending in the longitudinal direction, as shown in FIG. 6, by which means cooperation thereof with a corresponding projection on the molded piece prevents any forceful lateral displacement of the molded piece. Instead of groove 21, housing 20 could be provided with a projection and the molded piece with a recess.

As an alternative to the method of installing the media-conveying means described in FIG. 8, the parts could be embedded by casting in a suitable filling compound. The conduits and/or conductors for media and signals respectively and/or display units 7, 8, 55 may alternatively be molded with the material of the molded piece.

The housing 20 shown in FIG. 6 is in the form of a peripherally closed housing, i.e., it is closed all round and delimits the underside with the recess 9. All of the parts in grip element 3 are individually safely housed and can be separately cleaned and kept in order, irrespective of what parts are accommodated in the media carrier.

The hand instrument is fully operable even when no media carrier is present, that is to say, it can be used without media carrier when no medium is required. In such cases, however, it is advantageous to provide and use a “dummy” of the same shape as the molded piece, particularly on account of the resulting improved feel in the hand and improved handling.

FIG. 9 shows an alternative form for the molded piece 5. Molded piece 22 is in this case made completely of a light-conveying material. The molded piece can, for example, be in the form of a glass body which is appropriately ground at both ends corresponding to the light inlet and light outlet respectively. Such a variant is of advantage when light is required at the treatment site when working with the hand instrument and the light is produced in connecting element 4 or in the flexible supply tubing. The glass body may also have media-conveying conduits or conductors (not shown).

As an alternative to such an embodiment, an advantageous variant is conceivable in which an optical fiber 23 is placed in a molded piece made of a non-light-conveying material, for example, a plastics material.

Optical fiber 23 can, for example, be embedded in an article of plastics material by injection molding. Such a variant is indicated in FIG. 9.

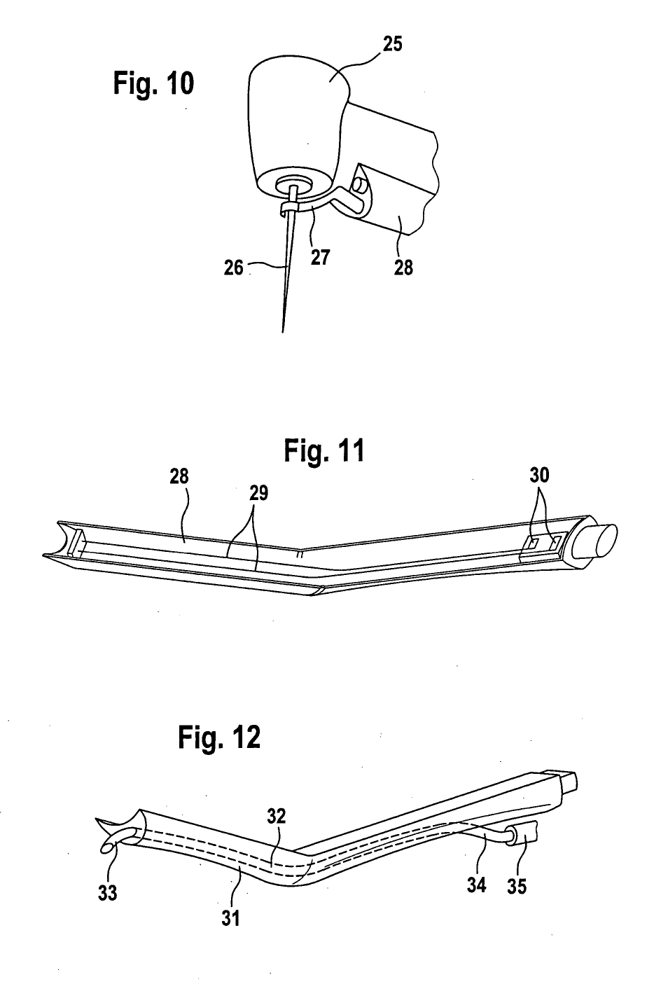

FIG. 10 illustrates an advantageous application utilizing a hand instrument for measuring the depth of a root canal of a tooth.

In the head piece 25 of this hand instrument there is mounted a tool 26. The driving mechanism (not shown) for this tool imparts oscillating, reciprocating, or rotary motion thereto. In the direct vicinity of the shaft of the tool there is disposed a sensor element 27, by means of which movement of the tool in the axial direction can be detected. For this purpose, sensor element 27 can rest directly against the shaft of the tool.

By using the sensor element 27, in this case in the form of a contact, it is possible, in conjunction with a patient's contact, to effect capacitive measurement via the tool 26, for example. The signals thus obtained are passed through signal conductors 29 located in a molded piece 28 to the rear end thereof. The signal conductors end in sensor elements 30, which, in the coupled state, mate with cooperating contacts disposed in the connecting element of the hand instrument and pass the signals on to a control unit positioned outside the hand instrument for further utilization thereof.

Instead of sensor element 27, it is possible to sense the movement of the tool, if desired. Such an advantageous variant can be provided in this or a similar embodiment for detection of the rotary speed, the direction of rotation, or the axial movement of a tool. The sensor can be an opto-electronic or acoustic sensor, which produces appropriate signals depending on, for example, the rotary speed or the frequency of reciprocation of the tool, which signals can be passed to a control unit in the aforementioned manner for utilization and display purposes.

FIG. 12 shows another advantageous variant of a molded piece. In this case, the molded piece 31 contains an embedded fine conduit 32, which has a bent end 33 facing the head piece and directed toward the site of treatment. The other end 34 projects outwardly from the rear region and is adapted for attachment to a flexible conduit 35 through which a rinsing liquid can be withdrawn from an external source, optionally with admixture of a pharmaceutical preparation. Such a variant can be used to advantage for achieving sterile rinsing of root canals in root canal treatment.

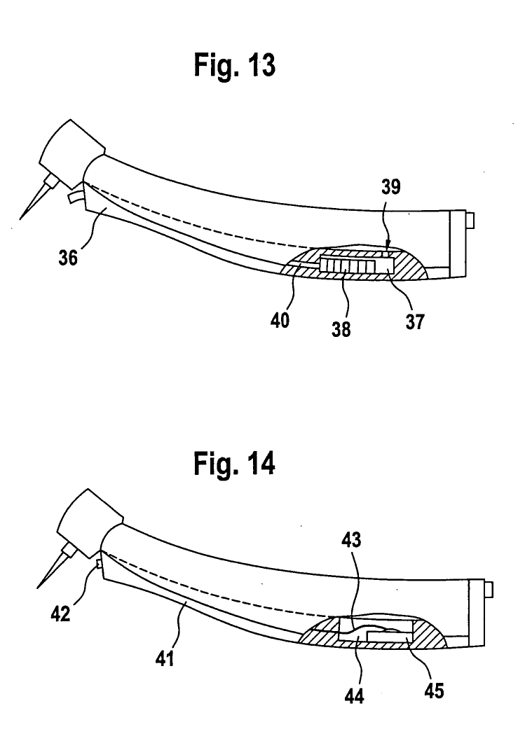

A more elegant variant is illustrated in FIG. 13. The molded piece 36 has in this case a container or reservoir 37 for the accommodation of a pharmaceutical preparation, in this case in the form of medicinal tablets 38. Water coming from the flexible supply conduit is passed to container 37 through a radial channel 39 and passes through the container to the head piece of the hand instrument via a conduit 40 located in the molded piece. In order to obtain sterile water, suitable NaOCl pellets may be placed in container 37, which pellets will dissolve as the water passes through. It will be appreciated that other administration forms can be added, for example powders, gels, or liquids.

Through the media conduits there may also be passed freezing sprays, fillers for the root canal, vaccine matters, or pharmaceutical preparations, particularly from external sources.

Another equally advantageous variant of a molded piece having an integrated lighting unit is illustrated in FIG. 14. Molded piece 41 contains in this case illuminating means 42 directed toward the site of treatment and in the form of, say, an LED connected via a conductor 43 to a source of energy 45 disposed in a recess 44 and in the form of, say, a button cell for electrical energy. The molded piece forms in this case a self-sufficient illuminating unit independent of the other energy supply to the hand instrument. Furthermore, a switching function can be provided on the molded piece. An illuminant of any suitable wavelength can be used.

As mentioned above, it may be advantageous for the hand instrument to contain not just one media carrier, as illustrated in the previous embodiments, but a plurality of media carriers advantageously disposed in even distribution around the periphery of the hand instrument.

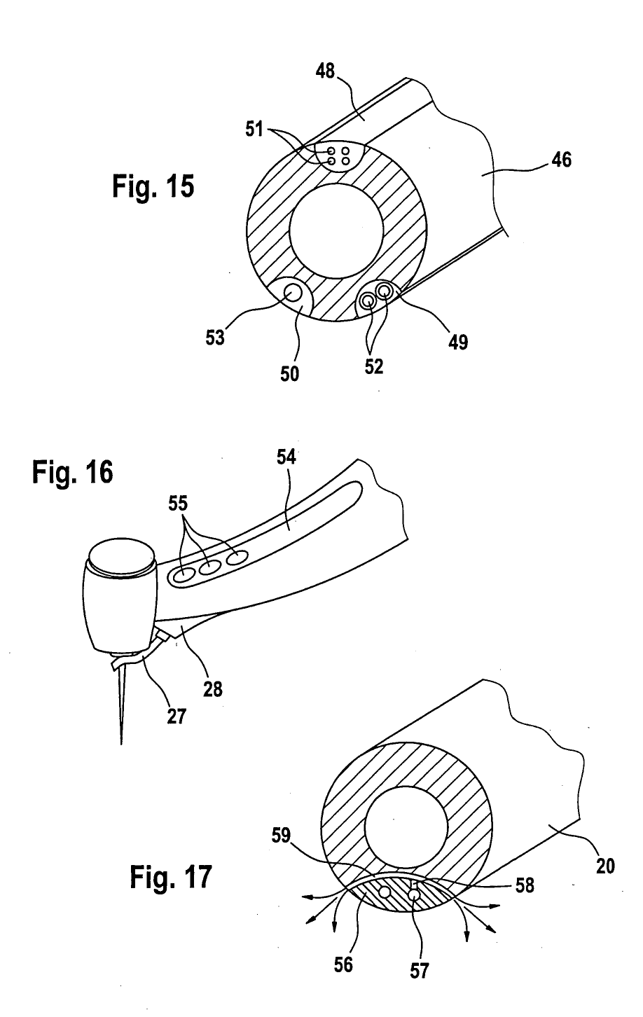

Such an embodiment will now be described with reference to FIG. 15. FIG. 15 is a greatly simplified illustration (not showing internal parts) of a basic module 46 which contains three recesses around its periphery (each of which may have a form similar to recess 9 in FIG. 6), in which molded pieces 48, 49, 50 conveying three different media are placed. One molded piece 48 contains conductors 51 for conducting electric current or for transferring signals, the second molded piece 49 contains two fine tubes 52 for conveying atomizing air and spray water, whilst the third molded piece 50 contains an optical fiber 53 for conveying light as described above.

A hand instrument of this design makes it possible to provide individual, application-specific supplies of media without having to alter the basic module itself. Here again, when, in individual cases, certain media are lacking or not required, the respective recesses may be covered or closed by dummy moldings.

FIG. 16 shows, by way of example, an embodiment of a hand instrument to be used for root canal treatment. The hand instrument contains on its underside the molded piece 28 already described with reference to FIG. 10 and having a sensor element 27 for determination of the length of a root canal, and also has on its top surface another molded piece 54, in which three indicators 55 (LED's) are disposed. As may be seen from the drawing, the molded piece does not extend over the entire length of the grip element, as is the case with the embodiments discussed previously, but only over a short region of the grip element. The indicators 55 are electrically connected to sensor element 27 and can, for example, indicate the depth of penetration of the root canal instrument.

Each molded piece can be provided with identification means to make its function clearly distinguishable. Such identification means can take the form of different colors or different surface characteristics or any other means.

According to the invention, a dental surgical handpiece can be provided which can be readily cleaned due to the fact that it comprises only a few self-contained subassemblies or parts which can be disassembled and reassembled in a simple manner. This dental surgical handpiece can be provided with all of the added features commonly provided in modern handpieces, such as light and spraying means, without detriment to its cleaning possibilities.

This is augmented by the fact that a media carrier 56 is provided which has rinsing orifices 58 leading from a pressurized media conduit 57 to the housing 20. This produces excessive pressure in the gap 59 between media carrier 56 and housing 20, which forms a stream of rinsing liquid and prevents the adherence of contaminating substances or germs. The gap can be sealed at its external edges so that possibly only a few rinsing orifices will suffice.

1-30. cancel.

31. A dental hand instrument, comprising a first functional unit, which contains a functional part, a grip element, a connecting element for the attachment of a supply element for media such as air, water, electric current, light and/or signals, and a second functional unit mounted on said first functional unit wherein,
said first functional unit has a peripherally closed external housing having a recess that retreats toward the interior of the external housing and serves to at least partially accommodate at least one media carrier,
said second functional unit contains said at least one media carrier for conduits and/or conductors for conveying media and/or signals respectively,
said media carrier is designed such that when coupled to said first functional unit the carrier forms a continuation of at least part of the peripheral contour of the grip element, and
said second functional unit extends along said grip element.

32. A dental hand instrument as defined in claim 31, wherein said first functional unit and said second functional unit have retaining means for effecting a releasable connection therebetween.

33. A dental hand instrument as defined in claim 31, wherein said media carrier on said second functional unit cooperates with the connecting element of said first functional unit such that media and/or signals required by said second functional unit can be transferred from said connecting element to said second functional unit at complementary transfer points.

34. A dental hand instrument as defined in claims 31, wherein said media carrier on said second functional unit has a transfer point which is independent of said connecting element and which serves to transfer media and/or signals required by said second functional unit.

35. A dental hand instrument as defined claim 31, wherein said first functional unit has at one end thereof a head piece having means for accommodating a dental tool and at appropriate end thereof a connecting element and also means for transferring energy and/or signals to and/or from said tool and is a unit independent of said tool and means for holding said unit in the hand.

36. A dental hand instrument as defined in claim 33, wherein said first functional unit comprises a driving mechanism for a dental tool.

37. A dental hand instrument as defined in claim 36, wherein said tool is adapted for rotation or oscillation.

38. A dental hand instrument as defined in claim 36, wherein said dental tool comprises a sprayer.

39. A dental hand instrument as defined in claim 36, wherein said dental tool comprises a light of arbitrary wavelength.

40. A dental hand instrument as defined in claim 36, wherein said dental tool comprises a laser light.

41. A dental hand instrument as defined in claim 36, wherein said dental tool is a comprises a probe.

42. A dental hand instrument as defined in claim 31, wherein said second functional unit comprises a plurality of media carriers disposed around the periphery of said grip element

43 A dental hand instrument as defined claim 31, wherein said media carrier comprises a boat-shaped molded piece, in recesses of which conduits and/or conductors for media and signals respectively and/or display units are located.

44. A dental hand instrument as defined in claim 31, wherein said molded piece contains means for effecting releasable installation of said conduits and/or conductors for media and signals respectively and/or display units comprising clamping elements.

45. A dental hand instrument as defined in claim 31, wherein said conductors and conduits for media are mounted in said media carrier at an end thereof remote from said functional part in an insert having radial coupling means to media feedlines or conductors in said connecting element.

46. A dental hand instrument as defined in claim 31, wherein at least one of said media carriers has at an end thereof remote from said functional part a projecting pin, in an end face of which at least one conduit or conductor ends, and said connecting element of said first functional unit having a complementary recess which receives said pin such that an active connection is established for the transference of said media and/or signals.

47. A dental hand instrument as defined in claim 31, wherein said media carrier contains contact or sensor means adjacent said head piece which receive signals which are passed through signal conductors disposed in said media carrier, the ends of said signal conductors being provided with contacts which wherein coupled to said first functional unit cooperate with complementary contacts in said connecting element.

48. A dental hand instrument as defined in claim 47, wherein sensor means are provided which sense movement, such as a rotary movement or the direction of rotation, of a tool mounted in said functional part.

49. A dental hand instrument as defined in claim 31, wherein said media carrier, is at least partially resilient.

50. A dental hand instrument as defined in claim 31, wherein said media carrier is in the form of a use-once-only part.

51. A dental hand instrument as defined in claim 31, wherein said media carrier is in the form of a blank.

52. A dental hand instrument as defined in claim 31, wherein said media carrier comprises a light-conducting material.

53. A dental hand instrument as defined in claim 31, wherein said media carrier contains a conduit having an end remote from said head piece adapted for the connection of an external flexible conduit for feeding in a rinsing liquid.

54. A dental hand instrument as defined in claim 31, wherein said media carrier can be attached by means of a retaining ring capable of being pushed onto said grip element.

55. A dental hand instrument as defined in claim 31, wherein said media carrier can be attached by means of a mating surface provided in the region of said functional part and by a locking ring disposed an end of said grip element which is remote from said functional part.

56. A dental hand instrument as defined in claim 31, wherein said media carrier and grip element have self-locking means particularly in the region of said recess.

57. A dental hand instrument as defined in claim 31, wherein said media carrier contains a container for accommodation of a mixture of substances and also conduits for feeding said liquid into said container and conveying it therethrough.

58. A dental hand instrument as defined in claim 31, wherein said media carrier contains accommodation means for a source of electrical energy and also conductors for supplying energy to an illuminant disposed at an end of said media carrier from a source of energy disposed in said media carrier.

59. A dental hand instrument as defined in claim 31, wherein a first media carrier is provided which contains indicators which cooperate with sensor means optionally disposed in a second media carrier.

60. A dental hand instrument as defined in claim 31, wherein a media carrier is provided with rinsing orifices leading from a pressurized media conduit to said housing
